(19) United States
(12) Patent Application Publication
(10) Pub. No.: US 2012/0139143 A1
(43) Pub. Date: Jun. 7, 2012

(54) PLASTICIZING AGENT, COMPOSITION FOR POLYACRYLONITRILE-BASED PRECURSOR AND FABRICATION METHOD OF CARBON FIBER

(75) Inventors: Tun-Fun Way, Hsinchu City (TW); Kai-Jen Hsiao, Miaoli County (TW); Shi-Kuang Hwang, Hsinchu City (TW); Jiun-Jy Chen, Miaoli County (TW); Hsiao-Chuan Chang, Hsinchu County (TW); Yu-Ting Chen, Changhua County (TW)

(73) Assignee: INDUSTRIAL TECHNOLOGY RESEARCH INSTITUTE, Hsinchu County (TW)

(21) Appl. No.: 13/079,816

(22) Filed: Apr. 5, 2011

(30) Foreign Application Priority Data
Dec. 6, 2010 (TW) 099142310

(51) Int. Cl. D01F 9/12; C08L 35/04; C08F 222/30

(52) U.S. Cl. 264/29.2; 526/321; 526/325; 525/225

(57) ABSTRACT

A plasticizing agent and a composition for fabricating a polyacrylonitrile-based fiber precursor and a fabrication method of a polyacrylonitrile-based carbon fiber are provided. The plasticizing agent includes a copolymer represented by formula (I) or a derivative of formula (I):

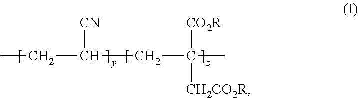

wherein R is methyl or ethyl, z≧0.5 mol %, and y=99.5-85.0 mol %. The plasticizing agent has an intrinsic viscosity of between 0.20-0.40 dL/g. The composition for fabricating the polyacrylonitrile-based fiber precursor includes the plasticizing agent and a polyacrylonitrile-based copolymer having an intrinsic viscosity of between 0.41-0.75 dL/g.

### CROSS REFERENCE TO RELATED APPLICATIONS

This application claims priority of Taiwan Patent Application No. 99142310, filed on Dec. 6, 2010, the entirety of which is incorporated by reference herein.

### BACKGROUND

1. Technical Field

The invention relates to a plasticizing agent, and more specifically to a plasticizing agent for fabricating a polyacrylonitrile-based fiber precursor.

2. Description of the Related Art

Conventional methods for fabricating a polyacrylonitrile-based fiber precursor are a wet-spinning method and a melt-spinning method, wherein the wet-spinning method is performed by using a solvent to form the polyacrylonitrile-based fiber precursor. However, the wet-spinning method requires performing a solvent recovery process and a fiber washing and drying process, such that the wet-spinning method has an environmental issue and an energy consumption issue. The melt-spinning method can avoid the environmental issue of the wet-spinning method which comes from using the solvent. However, the melt-spinning method has some disadvantages such as a high fiber breakage ratio, the difficulty in rolling the fibers, and a spinning rate lower than 70 m/min. Therefore, the polyacrylonitrile raw material of the polyacrylonitrile-based fiber precursor needs to be modified to become a polyacrylonitrile-based copolymer containing a high content of copolymerizing monomers or a plasticizing agent must be added into the polyacrylonitrile raw material to decrease the melting point of the spinning raw material to decrease the viscosity of the melting spinning raw material.

Currently, the conventional plasticizing agents used for fabricating the polyacrylonitrile-based fiber precursor include a water plasticizing agent, a solvent plasticizing agent or a low molecular weight compound. The water plasticizing agent and the solvent plasticizing agent with a low boiling point cause an unstable high pressure during the spinning process which makes water or solvent draining quick during decompression, such that a large number of voids are produced in the fibers and the strength of the fibers are reduced. The solvent plasticizing agent with a high boiling point and the plasticizing agent of low molecular weight compound make it difficult to eliminate the plasticizing agent from the polyacrylonitrile-based fiber, such that the subsequent formed carbon fibers from the polyacrylonitrile-based fiber have poor physical properties.

Therefore, a plasticizing agent for fabricating a polyacrylonitrile-based fiber precursor which overcomes the above mentioned problems is desired.

### SUMMARY

One embodiment of the invention provides a plasticizing agent for fabricating a polyacrylonitrile-based fiber precursor, comprising a copolymer represented by Formula (I) or a derivative of Formula (I):

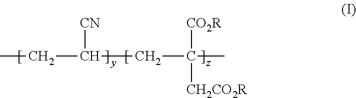

In Formula (I), R is methyl or ethyl, z≧0.5 mol %, and y=99.5-80.0 mol %. The plasticizing agent has an intrinsic viscosity of between 0.20-0.40 dL/g.

Another embodiment of the invention provides a composition for fabricating a polyacrylonitrile-based fiber precursor, comprising a plasticizing agent and polyacrylonitrile-based copolymer, wherein the amount of the plasticizing agent is 0.5-15.0 weight percent of the sum of the plasticizing agent and the polyacrylonitrile-based copolymer. The plasticizing agent comprises a copolymer represented by Formula (I) or a derivative of Formula (I):

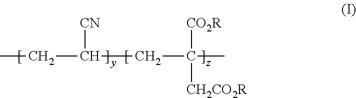

In Formula (I), R is methyl or ethyl, z≧0.5 mol %, and y=99.5-80.0 mol %. The plasticizing agent has an intrinsic viscosity of between 0.20-0.40 dL/g.

The polyacrylonitrile-based copolymer comprises a copolymer represented by Formula (II) or a derivative of Formula (II):

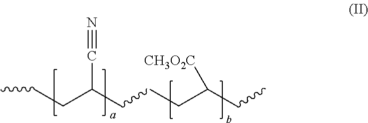

In Formula (II), a=90.0-80.0 mol % and b=10.0-20.0 mol %. The polyacrylonitrile-based copolymer has an intrinsic viscosity of between 0.41-0.75 dL/g.

Further, one embodiment of the invention provides a method for fabricating a polyacrylonitrile-based carbon fiber, comprising: providing the composition of the invention for fabricating a polyacrylonitrile-based fiber precursor; performing a wet-spinning process or a melt-spinning process on the composition to form a fiber precursor; performing an oxidization process on the fiber precursor to form an oxidized fiber; and performing a thermal treatment on the oxidized fiber to form the polyacrylonitrile-based carbon fiber.

A detailed description is given in the following embodiments.

### DETAILED DESCRIPTION

The following description is an embodiment of carrying out the invention. This description is made for general principles of the invention and should not be taken in a limiting sense.

As the disclosure of the inventors of this invention disclosed in Taiwan Patent Application No. 98146307, poly(acrylonitrile-co-dimethyl itaconate) referred to as poly(AN-co-DMI) does not contain acidic or basic copolymers, but has similar acidic or basic catalysis effects under an oxidization process of a fiber precursor formed from the poly(AN-co-DMI). Therefore, oxidization and cyclization reactions of the fiber precursor may be proceeded under low-temperature oxidization, thus, improving the oxidization ratio of fiber precursor sand shortening the time for fiber precursor oxidization. Moreover, the fiber precursor of poly(AN-co-DMI) does not contain acidic or basic compounds, thus reducing the probability of the fiber precursor being combined with inorganic metal ions, such that the amount of defects produced in carbon fibers formed from the fiber precursor of poly(AN-co-DMI) are reduced.

An embodiment of the invention provides using poly(AN-co-DMI) or derivatives of poly(AN-co-DMI) as a plasticizing agent for fabricating a polyacrylonitrile-based fiber precursor. The molecular weight of the plasticizing agent is lower than the molecular weight of a polyacrylonitrile-based copolymer for fabricating the polyacrylonitrile-based fiber precursor, thus the polyacrylonitrile-based fiber precursor can be fabricated by a melt-spinning process, wherein the fiber breakage ratio is reduced during the melt-spinning process, and the fibers are able to be rolled successfully. Also, spinning rate is enhanced to about 1000 m/min and the disadvantages of spinning without a plasticizing agent are overcome. Moreover, the molecular structure of the plasticizing agent is similar to the molecular structure of the polyacrylonitrile-based copolymer for fabricating the polyacrylonitrile-based fiber precursor, thus the plasticizing agent can be remained in the polyacrylonitrile-based fiber product. Therefore, the problems of the conventional plasticizing agents such as high boiling point solvent plasticizing agents or low molecular weight compound plasticizing agents which are difficult to be eliminated from the polyacrylonitrile-based fiber product are overcome.

In addition, an embodiment of the invention uses a dimethyl itaconate (DMI) based polymer as a plasticizing agent for fabricating a polyacrylonitrile-based fiber precursor. The DMI-based polymer plasticizing agent can catalyze oxidization and cyclization reactions of a polyacrylonitrile during performing of the oxidization process of the polyacrylonitrile-based fiber precursor to enhance oxidization ratio of oxidized fibers thereof. Thus, the time and the initial temperature of oxidization of a polyacrylonitrile-based fiber are decreased. The disadvantages of conventional melt-spinning technology such as high-temperatures or long process times for oxidization of a polyacrylonitrile-based fiber are overcome according to the embodiment of the invention. The high-temperature or the long-time of oxidization in the conventional melt-spinning technology causes carbon fibers to contain a great amount of voids and the structure of the carbon fibers is destroyed.

In an embodiment of the invention, the plasticizing agent includes a poly(AN-co-DMI) copolymer represented by Formula (I) or a derivative of Formula (I):

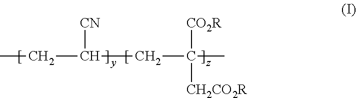

In Formula (I), R is methyl or ethyl, z≧0.5 mol %, and y=99.5-80.0 mol %. The plasticizing agent has an intrinsic viscosity of between 0.20-0.40 dL/g.

The precursor raw material for fabricating a polyacrylonitrile-based fiber precursor includes a poly(AN-co-MA) copolymer represented by Formula (II) or a derivative of Formula (II):

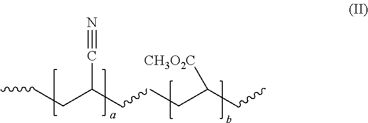

In Formula (II), a=90.0-80.0 mol % and b=10.0-20.0 mol %. The polyacrylonitrile-based copolymer has an intrinsic viscosity of between 0.41-0.75 dL/g.

In an embodiment of the invention, the amount of the plasticizing agent is 0.5-15.0 weight percent of the sum of the plasticizing agent and the polyacrylonitrile-based copolymer.

In an embodiment, the plasticizing agent and/or the polyacrylonitrile-based copolymer may be poly(acrylonitrile-co-methyl acrylate-co-dimethyl itaconate) referred to as poly(AN-co-MA-co-DMI) copolymer represented by Formula (III), but the molecular weight of the plasticizing agent is lower than the molecular weight of the polyacrylonitrile-based copolymer, and the plasticizing agent and the polyacrylonitrile-based copolymer may have the same molecular structure:

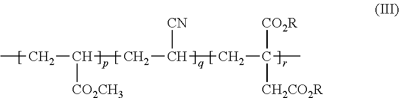

In Formula (III), R is methyl or ethyl, p+r=0.5-15.0 mol %, r≧0.5 mol %, q=99.5-85.0 mol % and p+q+r=100 mol %.

The plasticizing agent of the invention not only can be used in a melt-spinning process for fabricating a polyacrylonitrile-based fiber precursor but can also be used in a wet-spinning process for fabricating a polyacrylonitrile-based fiber precursor. The plasticizing agent is more effective in the melt-spinning process than the wet-spinning process. Thus, the following examples and comparative examples are performed by a melt-spinning process for fabricating a polyacrylonitrile-based fiber precursor.

According to an embodiment of the invention, first, a plasticizing agent is added into a polyacrylonitrile-based copolymer to form a composition of a raw material for fabricating a polyacrylonitrile-based fiber precursor. A melt-spinning process is performed on the raw material to form a fiber precursor. The temperature of the melt-spinning process is between 170° C. and 220° C. The fiber precursor produced by the melt-spinning process has a strength of about 0.1-10 g/den, preferably 2.0-4.0 g/den and elongation of about 0.1-60%, preferably 5.0-12.0%.

Next, an oxidization process is performed on the fiber precursor to form an oxidized fiber. In an embodiment, the oxidization process is performed at a temperature schedule from 130° C. to 160° C. to 180° C. to 200° C. to 230° C., and each temperature is held for one hour. The resulting oxidized fibers have a strength of about 0.1-5 g/den, preferably 1.4-3.0 g/den, and elongation of about 0.1-45%, preferably 3.0-10%, and a density of about 1.25-1.45 g/cm3, preferably 1.25-1.45 g/cm3, and a limiting oxygen index (LOI) of about 28-65, preferably 45-65.

Then, a thermal treatment process is performed on the oxidized fiber to form a polyacrylonitrile-based carbon fiber. In an embodiment, the thermal treatment process is performed at a temperature of about 600° C.-1200° C. The resulted carbon fiber has a strength of about 2.1-2.8 GPa, and elongation of about 1.6-1.8% and a density of about 1.6-1.7 g/cm3. Compared with the comparative examples, the carbon fibers obtained from the examples which were fabricated by adding the plasticizing agents of the invention have significantly enhanced strengths and densities.

The raw material compositions for fabricating polyacrylonitrile-based fiber precursors and the oxidization ratios of oxidized fibers of the Examples and Comparative Examples are described as below:

In the following Examples and Comparative Examples, the composition ratios of the copolymers were calculated from the ¹HNMR spectrum. For example, Poly(AN85.0-co-DMI15.0) represents 85.0 mol % of AN derivatives and 15.0 mol % of DMI derivatives in the copolymer. For polymerization of the disclosed Poly(AN-co-MA) copolymers of the Examples and the Comparative Examples, reference may be made to the method of International Patent No. WO 2008/140533. For polymerization of the disclosed Poly(AN-co-DMI) copolymers and the disclosed Poly(AN-co-MA-co-DMI) copolymers and methods for fabricating the fiber precursors thereof of the Examples, reference may be made to the method of Taiwan Patent Application No. 98146307.

The analysis methods:

The method for testing the fiber strength and elongation of the polyacrylonitrile-based fiber precursors and oxidized fibers: The testing machine was an automatic strength and elongation tester (Zwick/1445). The specimen: a fiber group with a length of at least 5 cm was removed from a sample. The fiber group was then separated into single fibers using a proper method. The drawn single fiber was then utilized as the specimen. The fiber strength and elongation test: The specimen was installed on the fixture of the strength and elongation tester. The test condition is described as follows. The fiber strength and elongation of the specimen were tested when being fractured. The tensile speed was 1 mm/min. The clipping distance was 25 mm±0.5 mm.

The method for testing the fiber strength and elongation of the carbon fibers: The testing machine was an automatic strength and elongation tester (Zwick/1445). The specimen: a fiber group with a length of at least 5 cm was removed from a sample. The fiber group was then separated into single fibers using a proper method. The drawn single fiber was then utilized to prepare the specimen. The open-cell paper: The thickness of the paper was about 0.3 mm. The width of the paper was about 20 mm. The length of the paper was about 45 mm. The length of the open-cell in the paper was about 25±0.5 mm. The width of the open-cell in the paper was about 10 mm. The single fiber was straightened along the central line of the paper. The upper and lower parts of the single fiber with a specified length were fixed using an adhesive. The specimen for a tensile test was thus prepared. The fiber strength and elongation test: The specimen was installed on the fixture of the strength and elongation tester. The central part of the paper was fractured. The test condition is described as follows. The fiber strength and elongation of the specimen were tested when being fractured. The tensile speed was 1 mm/min. The clipping distance was 25 mm±0.5 mm.

The method for testing the density: Reference is made to the method of CNS13553. The testing machine was a density gradient tube tester (single tube-type Daventest). The specimen preparation: a fiber group was made into a circle and 5 pieces of circular samples were prepared. The air bubbles on the surface of the fibers were removed. The circular samples were dipped in a density test mixing solution and then placed in a drying dish for pumping to vacuum for one hour by connection with a pump (a condensation tube filled with liquid nitrogen). The pump was turned off and the drying dish was left standing in a vacuum overnight. The specimen for a density test was thus prepared. The density test: The sample was taken from the drying dish and put into a carrier and then the carrier was placed slowly at a rate of about 1.2 cm/min in the density gradient tube tester. The sample was placed in the density gradient tube tester for 24 hours to achieve balance in the density gradient tube tester. The position of a standard density ball and the position of the sample in the density gradient tube tester were read to calculate the density of the sample. Then, the sample was taken out from the density gradient tube tester.

The method for testing the limiting oxygen index (LOI): Reference is made to the method of ISO 4589-2 (Fire Instrumentation Research Equipment LTD). The LOI is the lowest amount of oxygen gas required for firing a fiber sample with a length of 80 mm in an oxygen gas and nitrogen gas mixture for 3 minutes.

### Examples 1-6

A low molecular weight plasticizing agent selected from Poly(AN-co-DMI) copolymers and Poly(AN-co-MA-co-DMI) copolymers was added into a high molecular weight raw material selected from Poly(AN-co-MA) copolymers and Poly(AN-co-MA-co-DMI) copolymers to form the raw material compositions for fabricating the polyacrylonitrile-based fiber precursors of the Examples 1-6. The components, the ratios and the intrinsic viscosities (I.V.) of the high molecular weight raw materials and the low molecular weight plasticizing agents are shown in Table 1.

A melt-spinning process with a spinning temperature of 170-210° C. and a rolling rate of 1000 m/min was performed on the raw material compositions of the Examples 1-6 to form fiber precursors. The strength of the resulting fiber precursors was 2.0-4.0 g/den. The elongation of the resulting fiber precursors was 5.0-12.0%.

The resulting fiber precursors of the Examples 1-6 were tested by a differential scanning calorimeter (DSC) with a heating rate of 10° C./min to obtain respective enthalpies (ΔH1) of the fiber precursors of the Examples 1-6. The enthalpies (ΔH1) represented the highest oxidization ratio of the fiber precursors.

Further, the fiber precursors of the Examples 1-6 were placed in an oven to perform thermal oxidization reaction. The temperature schedule of the thermal oxidization reaction was from 130° C. to 160° C. to 180° C. to 200° C. to 230° C. and each temperature was continued for one hour to form oxidized fibers of the Examples 1-6. The strength of the oxidized fibers of the Examples 1-6 was 1.4-3.0 g/den. The elongation of the oxidized fibers of the Examples 1-6 was 3.0-10%. The density of the oxidized fibers of the Examples 1-6 was 1.25-1.45 g/cm3. The limiting oxygen index (LOI) of the oxidized fibers of the Examples 1-6 was 45-65.

Then, the oxidized fibers of the Examples 1-6 were tested by a differential scanning calorimeter (DSC) with a heating rate of 10° C./min to obtain respective enthalpies (ΔH2). The enthalpies (ΔH2) represented the amount of the fiber precursors of the Examples 1-6 which were not oxidized after the oxidization process. Thus, (ΔH1−ΔH2) represented the amount of the fiber precursors of the Examples 1-6 which were oxidized after the oxidization process. Calculation of the oxidization ratios of the oxidized fibers was represented by the oxidization ratio (%)=100%×(ΔH1−ΔH2)/ΔH1 of Examples 1-6). The oxidization ratios of the oxidized fibers of the Examples 1-6 are shown in Table 1.

### Comparative Examples 1-2

A low molecular weight plasticizing agent selected from Poly(AN-co-MA) copolymers was added into a high molecular weight raw material selected from Poly(AN-co-MA) copolymers to form the raw material compositions for fabricating polyacrylonitrile-based fiber precursors of the Comparative Examples 1-2. The components, the ratios and the intrinsic viscosities (I.V.) of the high molecular weight raw materials and the low molecular weight plasticizing agents are shown in Table 1.

A melt-spinning process with a spinning temperature of 170-210° C. and a rolling rate of 1000 m/min was performed on the raw material compositions of the Comparative Examples 1-2 to form fiber precursors. The strength of the resulted fiber precursors was 2.0-4.0 g/den. The elongation of the resulted fiber precursors was 5.0-12.0%.

The fiber precursors of the Comparative Examples 1-2 were placed in an oven to perform a thermal oxidization reaction. The temperature schedule of the thermal oxidization reaction was from 130° C. to 160° C. to 180° C. to 200° C. to 230° C. and each temperature was continued for one hour to form oxidized fibers of the Comparative Examples 1-2. The strength of the oxidized fibers of the Comparative Examples 1-2 was 1.0-1.9 g/den. The elongation of the oxidized fibers of the Comparative Examples 1-2 was 10-30%. The density of the oxidized fibers of the Comparative Examples 1-2 was 1.10-1.21 g/cm3. The limiting oxygen index (LOT) of the oxidized fibers of the Comparative Examples 1-2 was 34-47.

Then, the oxidized fibers of the Comparative Examples 1-2 were measured by the same method of the oxidized fibers of the Examples 1-5 to obtain oxidization ratios thereof. The results are shown in Table 1.

Table 1. The components, the ratios and the intrinsic viscosities (I.V.) of the high molecular weight raw materials and the low molecular weight plasticizing agents of the Examples and the Comparative Examples, and the oxidization ratios of the oxidized fibers thereof

| | | | The component of | | |
|---|---|---|---|---|---|
| | The component of | | the low molecular | | |
| | the high molecular | | weight plasticizing | | |
| | weight raw material/ | Ratio | agent/intrinsic | Ratio | oxidization |
| | intrinsic viscosity | (wt %) | viscosity | (wt %) | ratio (%) |
| Example 1 | Poly(AN 85.0-co- | 96 | Poly(AN 85.0-co- | 4 | 54% |
| | MA 15.0)/(I.V. = | | DMI 15.0)/(I.V. = | | |
| | 0.72 dL/g) | | 0.21 dL/g) | | |
| Example 2 | Poly(AN 85.0-co- | 90 | Poly(AN 85.0-co- | 10 | 64% |
| | MA1 5.0)/(I.V. = | | DMI 15.0)/(I.V. = | | |
| | 0.72 dL/g) | | 0.21 dL/g) | | |
| Example 3 | Poly(AN 85.0-co- | 90 | Poly(AN 85.0-co- | 10 | 61% |
| | MA 15.0)/(I.V. = | | MA 7.5-co-DMI | | |
| | 0.72 dL/g) | | 7.5)/(I.V. = 0.34 dL/g) | | |
| Example 4 | Poly(AN 85.0-co- | 96 | Poly(AN 85.0-co- | 4 | 43% |
| | MA 15.0)/(I.V. = | | MA 7.5-co-DMI | | |
| | 0.72 dL/g) | | 7.5)/(I.V. = 0.34 dL/g) | | |
| Example 5 | Poly(AN 85.0-co- | 90 | Poly(AN 85.0-co- | 10 | 39% |
| | MA 15.0)/(I.V. = | | MA 12.0-co-DMI | | |
| | 0.72 dL/g) | | 3.0)/(I.V. = 0.36 dL/g) | | |
| Example 6 | Poly(AN 85.0-co- | 90 | Poly(AN 85.0-co- | 10 | 65% |
| | MA 12.0-co-DMI | | MA 12.0-co-DMI | | |
| | 3.0)/(I.V. = 0.72 | | 3.0)/(I.V. = 0.36 dL/g) | | |
| | dL/g) | | | | |
| Comparative | Poly(AN 85.0-co- | 80 | Poly(AN 85.0-co- | 20 | <10% |
| Example 1 | MA 15.0)/(I.V. = | | MA 15.0)/(I.V. = | | |
| | 0.72 dL/g) | | 0.37 dL/g) | | |
| Comparative | Poly(AN 98.0-co- | 30 | Poly(AN 98.0-co- | 70 | <10% (low rolling |
| Example 2 | MA 2.0)/(I.V. = 0.91 | | MA 2.0)/(I.V. = 0.22 | | rate) |
| | dL/g) | | dL/g) | | |

Next, a thermal treatment with a temperature of 600-1200° C. was performed on the oxidized fibers of the Examples 1-6 and the Comparative Examples 1-2, respectively to form carbon fibers. For the thermal treatment, reference may be made to Taiwan Patent Application No. 98146307. The strength of the carbon fibers of the Examples 1-6 was 2.1-2.8 Gpa. The elongation of the carbon fibers of the Examples 1-6 was 1.6-1.8%. The density of the carbon fibers of the Examples 1-6 was 1.6-1.7 g/cm3. The strength of the carbon fibers of the Comparative Examples 1-2 was 1.5-1.8 Gpa. The elongation of the carbon fibers of the Comparative Examples 1-2 was 1.4-1.8%. The density of the carbon fibers of the Comparative Examples 1-2 was 1.4-1.5 g/cm3. Compared with the carbon fibers of the Comparative Examples, the strength and the density of the carbon fibers of the Examples obtained from adding the plasticizing agents of the invention in the raw material were significantly enhanced.

As shown in Table 1, in the Examples, adding the low molecular weight plasticizing agents of DMI-based polymers in the high molecular weight raw materials of PAN-based copolymers can enhance the oxidization ratios of the oxidized fibers to above 39%. Thus, the plasticizing agents provided by the invention can reduce the fiber breakage rate of the polyacrylonitrile-based fiber precursors during the melt-spinning process to make the fibers be rolled successfully and enhance the spinning rate to 1000 m/min. Moreover, the plasticizing agents provided by the invention can also decrease the time for oxidization and the initial temperature for oxidization for the oxidized fibers, to prevent the subsequently formed carbon fibers from producing a great amount of voids therein, which may lead to the structure of carbon fibers being destroyed.

While the invention has been described by way of examples and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A plasticizing agent for fabricating a polyacrylonitrile-based fiber precursor, comprising a copolymer represented by Formula (I) or a derivative of Formula (I): 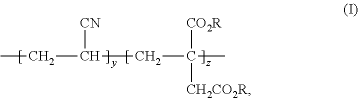
wherein in Formula (I):
R is methyl or ethyl;
z≧0.5 mol %; and
y=99.5-80.0 mol %, and
the plasticizing agent has an intrinsic viscosity of between 0.20-0.40 dL/g.

2. The plasticizing agent for fabricating a polyacrylonitrile-based fiber precursor as claimed in claim 1, wherein the polyacrylonitrile-based fiber precursor is fabricated from a polyacrylonitrile-based copolymer raw material comprising a copolymer represented by Formula (II) or a derivative of Formula (II): 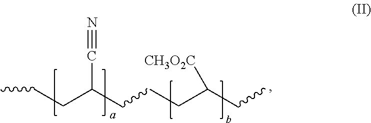
wherein in Formula (II):
a=90.0-80.0 mol %; and
b=10.0-20.0 mol %, and
the polyacrylonitrile-based copolymer raw material has an intrinsic viscosity of between 0.41-0.75 dL/g.

3. The plasticizing agent for fabricating a polyacrylonitrile-based fiber precursor as claimed in claim 2, where the amount of the plasticizing agent is 0.5-15.0 weight percent of the sum of the plasticizing agent and the polyacrylonitrile-based copolymer raw material.

4. The plasticizing agent for fabricating a polyacrylonitrile-based fiber precursor as claimed in claim 1, represented by Formula (III): 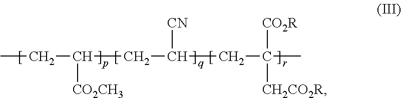
wherein in Formula (III),
R is methyl or ethyl, p+r=0.5-15.0 mol %, r≧0.5 mol %, q=99.5-85.0 mol %, and p+q+r=100 mol %.

5. A composition for fabricating a polyacrylonitrile-based fiber precursor, comprising:
a plasticizing agent, comprising a copolymer represented by Formula (I) or a derivative of Formula (I): 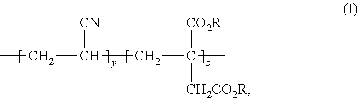
wherein in Formula (I), R is methyl or ethyl, z≧0.5 mol %, and y=99.5-80.0 mol %, and wherein the plasticizing agent has an intrinsic viscosity of between 0.20-0.40 dL/g; and
a polyacrylonitrile-based copolymer, comprising a copolymer represented by Formula (II) or a derivative of Formula (II): 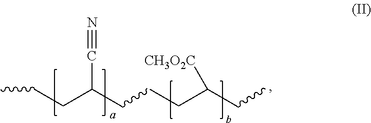
wherein in Formula (II), a=90.0-80.0 mol % and b=10.0-20.0 mol %, and wherein the polyacrylonitrile-based copolymer has an intrinsic viscosity of between 0.41-0.75 dL/g,
wherein the amount of the plasticizing agent is 0.5-15.0 weight percent of the sum of the plasticizing agent and the polyacrylonitrile-based copolymer.

6. The composition for fabricating a polyacrylonitrile-based fiber precursor as claimed in claim 5, wherein the plasticizing agent is represented by Formula (III): 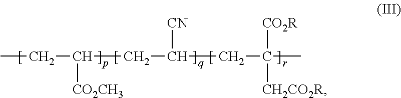
wherein in Formula (III), R is methyl or ethyl, p+r=0.5-15.0 mol %, r≧0.5 mol %, q=99.5-85.0 mol % and p+q+r=100 mol %.

7. The composition for fabricating a polyacrylonitrile-based fiber precursor as claimed in claim 5, wherein the polyacrylonitrile-based copolymer is represented by Formula (III): 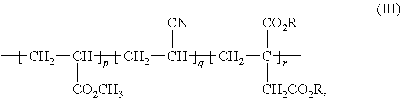
wherein in Formula (III), R is methyl or ethyl, p+r=0.5-15.0 mol %, r≧0.5 mol %, q=99.5-85.0 mol % and p+q+r=100 mol %.

8. The composition for fabricating a polyacrylonitrile-based fiber precursor as claimed in claim 5, wherein the plasticizing agent and the polyacrylonitrile-based copolymer have the same molecular structure.

9. A method for fabricating a polyacrylonitrile-based carbon fiber, comprising:
providing a composition for fabricating a polyacrylonitrile-based fiber precursor as claimed in claim 5;
performing a wet-spinning process or a melt-spinning process on the composition to form a fiber precursor;
performing an oxidization process on the fiber precursor to form an oxidized fiber; and
performing a thermal treatment on the oxidized fiber to form the polyacrylonitrile-based carbon fiber.

10. The method of fabricating a polyacrylonitrile-based carbon fiber as claimed in claim 9, wherein the melt-spinning process is performed at a temperature of 170-220° C.

11. The method of fabricating a polyacrylonitrile-based carbon fiber as claimed in claim 9, wherein the oxidization process is performed at a temperature schedule from 130° C. to 160° C. to 180° C. to 200° C. to 230° C., and each temperature is continued for one hour and the oxidized fiber has an oxidation ratio of above 39%.
